(19) United States
(12) Patent Application Publication
(10) Pub. No.: US 2016/0125131 A1
(43) Pub. Date: May 5, 2016

(54) POOL TEST RESULT VERIFICATION METHOD AND APPARATUS

(71) Applicants: SAMSUNG SDS CO., LTD., Seoul (KR); SAMSUNG LIFE PUBLIC WELFARE FOUNDATION, Seoul (KR)

(72) Inventors: Chang Seok KI, Seoul (KR); Seong Hyeuk NAM, Seoul (KR); Woo Yeon KIM, Seoul (KR); Yoo Jin HONG, Seoul (KR); Yong Seok LEE, Seoul (KR)

(73) Assignees: SAMSUNG LIFE PUBLIC WELFARE FOUNDATION, Seoul (KR); SAMSUNG SDS CO., LTD., Seoul (KR)

(21) Appl. No.: 14/928,304

(22) Filed: Oct. 30, 2015

(30) Foreign Application Priority Data
Oct. 31, 2014 (KR) 10-2014-0150327

(51) Int. Cl. G06F 19/22

(52) U.S. Cl. CPC G06F 19/22

(57) ABSTRACT

Provided are a method and apparatus for verifying pool test result. The method includes receiving pool test result data obtained by performing a pool test on a plurality of pools configured based on a two-dimensional (2D) matrix, the pool test result data including allele frequencies of the plurality of pools, extracting a pool-specific variant from the matrix using the allele frequencies determining whether there is an intersecting pool among pools intersecting, in the matrix, a pool showing the pool-specific variant and determining whether the pool test result data is erroneous based on results of the determining whether there is an intersecting pool.

This application claims priority to Korean Patent Application No. 10-2014-0150327 filed on Oct. 31, 2014 in the Korean Intellectual Property Office, the disclosure of which is incorporated herein by reference in its entirety.

### BACKGROUND

1. Field of the Invention

The invention relates to a pool test result verification apparatus and method for verifying pool test result data obtained from biological samples, and more particularly, to a pool test result verification apparatus and method for determining, for securing the reliability of variant detection result data, whether samples have been properly pooled in each pool by a predefined amount.

2. Description of the Related Art

Various gene testing techniques for testing genes that cause a particular virus or disease have been provided. However, testing each sample individually during a gene test may be rather time-consuming and costly. To reduce the time and cost of sample testing, various methods have been suggested in which several samples are pooled and then are tested at the same time.

In a pool test method, samples to be subjected to a gene test are arranged in a two-dimensional (2D) matrix, and samples belonging to each row or column of the matrix are pooled together so as to form pools to be subjected to the gene test.

However, in the process of pooling biological samples, some samples may be left out from being pooled or may not be pooled by a predefined amount for various reasons, such as an experimenter's carelessness or errors in testing equipment. Thus, to ensure the reliability of test result data when testing multiple gene samples at the same time, a technique is needed to verify whether samples are equally pooled without leaving out any samples.

### SUMMARY

Exemplary embodiments of the invention provide an apparatus and method for measuring and verifying a degree to which samples are pooled to ensure the reliability of pool test result data.

Exemplary embodiments of the invention also provide an apparatus and method for identifying any left-out sample or any sample not properly pooled by a predefined amount by analyzing pool test result data.

Exemplary embodiments of the invention also provide a method for in response to a sample not properly pooled by a predefined amount being detected in the process of pooling a plurality of biological samples, determining whether the sample is over-pooled by more than the predefined amount or under-pooled by less than the predefined amount, identifying the sample, and determining by at what percentage of the predefined amount the sample is pooled.

However, exemplary embodiments of the invention are not restricted to those set forth herein. The above and other exemplary embodiments of the invention will become more apparent to one of ordinary skill in the art to which the invention pertains by referencing the detailed description of the invention given below.

According to an exemplary embodiment of the invention, there is provided a method for verifying pool test result, the method comprising receiving pool test result data obtained by performing a pool test on a plurality of pools configured based on a two-dimensional (2D) matrix, the pool test result data including allele frequencies of the plurality of pools, extracting a pool-specific variant from the matrix using the allele frequencies, determining whether there is an intersecting pool among pools intersecting, in the matrix, a pool showing the pool-specific variant; and determining whether the pool test result data is erroneous based on results of the determining whether there is an intersecting pool.

According to an exemplary embodiment of the invention, determining whether there is an intersecting pool may comprises determining whether there is an intersecting pool by noise-filtering allele frequencies below a predefined value; and

According to an exemplary embodiment of the invention, determining whether the pool test result data is erroneous may comprises in response to a determination being made that there is no intersecting pool, determining again whether there is an intersecting pool by not noise-filtering even allele frequencies below the predefined value, and in response to a determination being made again that there is no intersecting pool, generating error reporting data indicating a sample pooling error.

According to an exemplary embodiment of the invention, determining whether there is an intersecting pool may comprises determining whether there is an intersecting pool by noise-filtering allele frequencies below a predefined value; and the step of the determining whether the pool test result data is erroneous may comprises in response to a determination being made that there is no intersecting pool, determining again whether there is an intersecting pool by not noise-filtering even allele frequencies below the predefined value, and in response to a determination being made that there is an intersecting pool, measuring sample pooling degrees of a sample having the pool-specific variant in the intersecting pool and the pool showing the pool-specific variant.

According to an exemplary embodiment of the invention wherein the sample pooling degrees are calculated by the following equation: (p*i/z)*f where p=2 in response to the sample being a diploid, p=1 in response to the sample being a haploid, i represents the number of pools intersecting, in the matrix, the pool showing the pool-specific variant, z=1 in response to the pool-specific variant being a heterozygous variant, z=2 in response to the pool-specific variant being a homozygous variant, and f represents an allele frequency of the pool-specific variant.

According to an exemplary embodiment of the invention wherein the determining whether the pool test result data is erroneous, further comprises: in response to the sample pooling degrees being greater than 1+α (where a represents a predefined error tolerance), generating error reporting data indicating over-pooling; in response to the sample pooling degrees being less than 1−β (where β represents a predefined error tolerance), generating error reporting data indicating under-pooling; and in response to the sample pooling degrees being in a range from 1+β to 1+α, generating error reporting data indicating normal pooling.

According to an exemplary embodiment of the invention, wherein the determining whether the pool test result data is erroneous, comprises in response to the sample pooling degrees being within a predefined error tolerance range, generating normal reporting data.

According to still another aspect of the present invention, there is provided a computer program recorded on a recording medium for executing, in connection with a computing device, the steps of: receiving pool test result data, which is obtained by performing a pool test on a plurality of pools configured based on a 2D matrix and includes allele frequencies of the plurality of pools; extracting a pool-specific variant from the matrix using the allele frequencies; determining whether there is an intersecting pool among pools intersecting, in the matrix, a pool showing the pool-specific variant; and determining whether the pool test result data is erroneous based on results of the determining whether there is an intersecting pool.

According to still another aspect of the present invention, there is provided a pool test result verification apparatus, the apparatus comprising, one or more processors; a network interface; a memory; and a storage device having recorded thereon an execution file of a computer program that is loaded in the memory to be executed by the processors, wherein the computer program comprises: instructions for receiving pool test result data, which is obtained by performing a pool test on a plurality of pools configured based on a 2D matrix and includes allele frequencies of the plurality of pools; instructions for extracting a pool-specific variant from the matrix using the allele frequencies and determining whether there is an intersecting pool among pools intersecting, in the matrix, a pool showing the pool-specific variant; and instructions for outputting data to display verification results of the pool test result data according to results of the determining whether there is an intersecting pool.

According to an exemplary embodiment of the invention, wherein the network interface is connected to an allele frequency measurement apparatus, and the computer program further comprises: instructions for receiving allele frequency frequencies from the allele frequency measurement apparatus via the network interface; and instructions for measuring a sample pooling degree in the intersecting pool and determining whether the pool test result data is erroneous based on the sample pooling degree.

According to still another aspect of the present invention, there is provided a pool test result verification apparatus, the apparatus comprising: a pool-specific variant extraction unit receiving pool test result data, which is obtained by performing a pool test on a plurality of pools configured based on a 2D matrix and extracting a pool-specific variant from the matrix using allele frequencies of the plurality of pools included in the pool test result data; an intersecting pool determination unit determining whether there is an intersecting pool among pools intersecting, in the matrix, a pool showing the pool-specific variant; and a sample pooling verification unit determining whether each sample has been properly pooled for the pool-specific variant based on the allele frequencies.

According to an exemplary embodiment of the invention, the apparatus further comprising, a sample pooling degree measurement unit determining whether sample pooling degrees in the pool showing the pool-specific variant and the intersecting pool are within a predefined error tolerance range.

According to the exemplary embodiments, one or more samples to be tested are collected to configure pools, the pools are tested, and pool test result data obtained by the testing can be verified for error.

Since a determination can be made as to whether the samples have been properly pooled, the reliability of the pool test result data can be improved.

Also, even if there is a sample pooling error, the number of samples that need to be tested individually can be reduced, thereby minimizing the time and cost of testing.

Other features and exemplary embodiments will be apparent from the following detailed description, the drawings, and the claims.

### BRIEF DESCRIPTION OF THE DRAWINGS

FIG. 1 is a schematic view of a sample analysis system according to an exemplary embodiment of the invention.

FIG. 2 is a schematic view of a sample analysis system according to another exemplary embodiment of the invention.

FIG. 3 is a schematic view illustrating a sample pooling process for creating data to be analyzed by a pool test result verification method according to an exemplary embodiment of the invention.

FIG. 4 is a schematic view illustrating a process of identifying samples having a variant using pooled samples and a pool-specific variant, as performed in a pool test result verification method according to an exemplary embodiment of the invention.

FIG. 5 is a flowchart illustrating a pool test result verification method according to an exemplary embodiment of the invention.

FIG. 6 is a detailed flowchart illustrating a process of determining whether there is an intersecting pool for a pool-specific variant, as performed in the pool test result verification method according to the exemplary embodiment of FIG. 5.

FIG. 7 is a detailed flowchart illustrating a process of calculating the allele frequencies of pools, as performed in the pool test result verification method according to the exemplary embodiment of FIG. 5.

FIG. 8 is a detailed flowchart illustrating a process of determining a ploidy value of a sample.

FIG. 9 is a detailed flowchart illustrating a process of calculating sample pooling degrees, as performed in the pool test result verification method according to according to the exemplary embodiment of FIG. 5.

FIGS. 10A, 10B, and 10C show allele frequencies of pools for cases where normal pooling, erroneous pooling, and under-pooling are respectively reported.

FIG. 11 is a block diagram of a pool test result verification apparatus according to an exemplary embodiment of the invention.

FIG. 12 is a hardware configuration view of the pool test result verification apparatus according to the exemplary embodiment of FIG. 11.

### DETAILED DESCRIPTION OF THE EMBODIMENTS

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. In the drawings, the size and relative sizes of layers and regions may be exaggerated for clarity.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. The terminology used herein is for the purpose of describing particular embodiments only and is not intended to be limiting of the invention. As used herein, the singular forms are intended to include the plural forms as well, unless the context clearly indicates otherwise

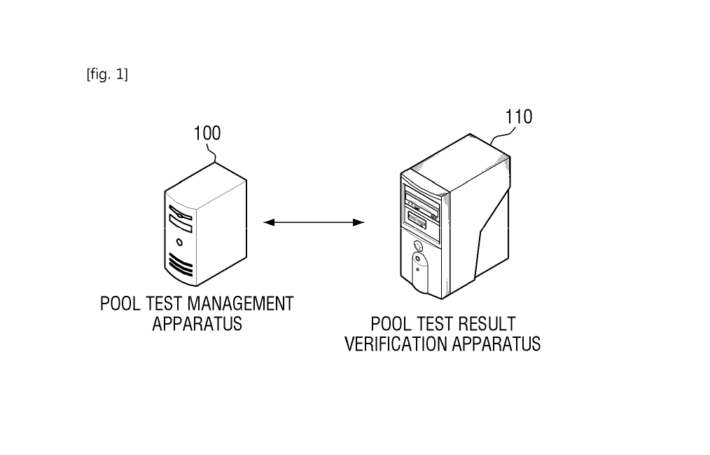

The structure and operation of a sample analysis system according to an exemplary embodiment of the invention will hereinafter be described with reference to FIG. 1. The sample analysis system according to the present exemplary embodiment includes a pool test management apparatus 100 and a pool test result verification apparatus 110.

The pool test management apparatus 100 configures a two-dimensional (2D) n*m matrix by pooling a plurality of biological samples and determines whether each pool has a specific biological characteristic. The pool test management apparatus 100 may record sample information indicating, for example, from whom each blood sample was drawn. The pool test management apparatus 100 may be configured to in response to a particular pool of a matrix showing a positive reaction to a specific biological characteristic, detect positive samples using a plurality of pools that intersect the particular pool in the matrix.

The pool test result verification apparatus 110 verifies pool matrix positive reaction result values obtained by pooling biological samples, as performed by the pool test management apparatus 100. A pool test result verification method is based on the assumption that samples are pooled at an equal ratio and one sample is pooled in one row pool and one column pool. The pool test result verification apparatus 110 determines whether each sample has been equally pooled and whether there is any left-out sample during pooling, and notifies the pool test management apparatus 100 of the results of the determination.

In response to error being reported from the pool test result verification apparatus 110, the pool test management apparatus 100 may test only the sample where the error has occurred to determine whether the corresponding sample shows a positive reaction to the specific characteristic or may perform an entire pool test again.

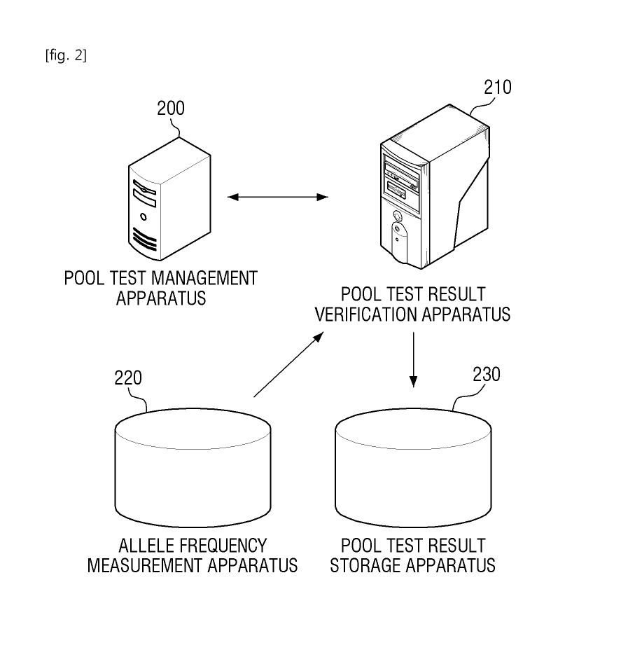

FIG. 2 is a schematic view of a sample analysis system according to another exemplary embodiment of the invention. The sample analysis system according to the present exemplary embodiment includes a pool test performing apparatus 200, a pool test result verification apparatus 210, an allele frequency measurement apparatus 220, and a pool test result storage apparatus 230.

The pool test performing apparatus 200 pools a plurality of samples and configures a pool matrix. In the present exemplary embodiment, like in the exemplary embodiment of FIG. 1, a determination may be made as to whether each pool of the matrix has a specific biological characteristic.

The pool test result verification apparatus 210 may verify test result data provided by the pool test performing apparatus 200. Also, the pool test result verification apparatus 210 may measure sample pooling degrees of the plurality of samples using allele frequency information and may detect an under-pooled sample, which is a sample pooled by less than a predefined amount, or an over-pooled sample, which is a sample pooled by more than the predefined amount. Also, the pool test result verification apparatus 210 may determine by what percentage of the predefined amount each of the plurality of samples is pooled based on the measured sample pooling degrees.

The allele frequency measurement apparatus 220 measures the frequency of an allele showing the specific biological characteristic. The allele frequency measurement apparatus 220 may determine a pool having more variants than a minimum required variant quantity to be positive.

The frequency of an allele may be a value obtained, based on reads mapped to a reference sequence, by dividing the total number of samples subjected to a pool test by the number of samples having a different sequence from the reference sequence to show a positive reaction to the specific characteristic.

For example, in a case when Single Nucleotide Polymorphisms (SNPs) are used as alleles, any one of AA, which is a reference genotype, AB, which is a heterozygous variant genotype, and BB, which a homozygous variant genotype, may be present at a corresponding variant position of a gene included in each sample. For convenience of understanding, diploids are exemplified, but the invention is not limited thereto.

To measure the frequency of an allele, Next Generation Sequencing (NGS) may be used as a method of measuring a signal indicating a variant genotype. NGS generates a large number of reads, which are sequence fragments of a uniform length, from a genomic area to be a target. The reads generated in this manner are mapped to a reference sequence, and a sequence of a specific area is rearranged based on sequence information on reads mapped to the specific area.

In the above example, a genotype at a specific position of a test target sample may be inferred from the allele frequencies at the corresponding positions in reads mapped to an area including the specific position. For example, in the case of genotype AB, which is a heterozygous genotype, the allele frequencies of A and B may be observed to be about ½ and ½, respectively. Also, when a sample having genotype AB and a sample having genotype BB are pooled, the allele frequencies of A and B may be observed to be about ¼ and ¾, respectively. Therefore, to examine whether samples have a specific SNP using NGS, the frequency of allele B present in variant genotypes AB and BB may be measured based on mapped reads.

Meanwhile, when the frequency of an allele is calculated based on mapped reads using NGS, if the genotype of a diploidic sample is AB, the frequency of alternative allele B may not necessarily be observed to be ½ or 1 at all times. This may be caused by errors such as a sequencing error or a mapping error. Therefore, in consideration of such error, it is possible to make it a rule to allocate test result values after determining a genotype as AB when an allele frequency is measured to be between 0.4 and 0.6 and as BB when the allele frequency is measured to be 0.8 or more. Alternatively, as another method for determining the genotype of a sample based on mapped reads, a statistical algorithm for calculating a likelihood or probability of a genotype, such as an SNVer algorithm (Wei et al., SNVer: a statistical tool for variant calling in analysis of pooled or individual next-generation sequencing data, Nucleic Acids Res. 39(19), 2011) may be used. The test value of each pool may also be determined using the rule or algorithm in consideration of the number of pooled samples. However, the rule or algorithm is merely means for implementing the invention, and the invention is not limited thereto.

In order to readily apply NGS to the invention, it is necessary to satisfy a condition that sequencing reads of samples pooled in each pool are approximately equally distributed in the sequencing result of the pool. For example, when four pooled samples have genotypes AA, AB, AB, and AA, respectively, the frequency of alternative allele B needs to be observed as 2/8 in the corresponding pool.

The allele frequency measurement apparatus 220 may accumulate and store the frequency of the allele showing the specific characteristic.

The pool test result verification apparatus 210 may receive allele frequency information from the allele frequency measurement apparatus 220 and may use the allele frequency information to determine whether there is an intersecting pool for a pool-specific variant and to determine sample pooling degrees.

The pool test result verification apparatus 210 may transmit test results corresponding to pools that are determined to have samples equally pooled therein to the pool test result storage apparatus 230.

As illustrated in FIG. 2, the allele frequency measurement apparatus 220 and the pool test result storage apparatus 230 may be storage areas provided in the pool test result verification apparatus 210, but the invention is not limited thereto. That is, the allele frequency measurement apparatus 220 and the pool test result storage apparatus 230 may be provided as separate servers connected to the pool test result verification apparatus 210.

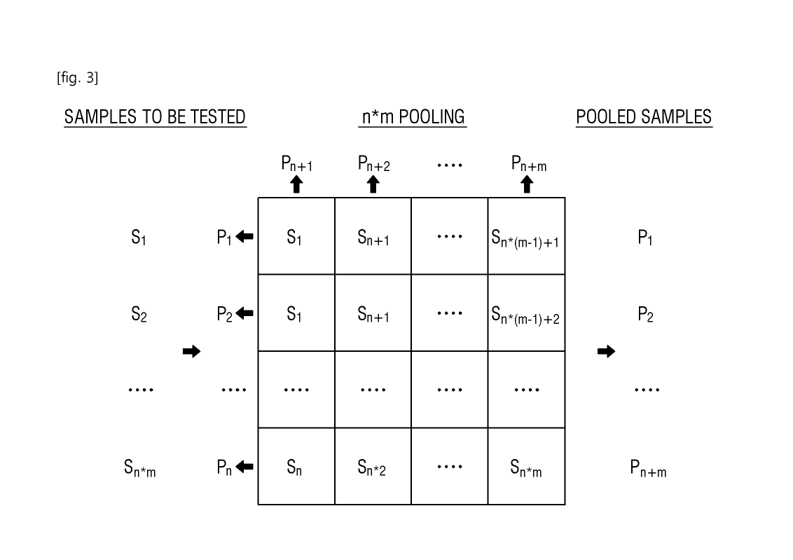

The configuration of pools from samples by the pool test management apparatus 100 or 200 is as illustrated in FIG. 3. Referring to FIG. 3, X (=n*m) samples S₁, S₂, S₃, . . . , and S_{n*m} are arranged in an n*m matrix, wherein n and m may be equal to, or different from, each other, n*m=X, and X may be equal to or greater than 2. The samples S₁, S₂, S₃, . . . , and S_{n*m}, may be samples to be tested whether they show a specific biological characteristic, and examples of the samples S₁, S₂, S₃, . . . , and S_{n*m} may include tissues or body fluids from all living organisms including humans.

Once the matrix is configured, the X samples, which are arranged in the matrix, may be pooled in k (=n+m) pools. Samples of the same row or column of the matrix may be pooled in the same pool. For example, as illustrated in FIG. 3, samples constituting a first row of the matrix are pooled in a pool P₁, and samples constituting a first column of the matrix are pooled in a pool Pₙ₊₁. Through this process, k pooled samples (or pools) P₁, P₂, . . . , and Pₙ₊ₘ are generated.

As illustrated in FIG. 3, the k pools in which samples are pooled may be tested for whether they show the specific characteristic. Since a plurality of samples are tested at the same time, it is necessary to determine which of the k pools are positive pools.

A positive sample may be a sample with a higher allele frequency than that can be measured from a sample having a specific characteristic. Sample testing is intended to detect samples showing a specific characteristic. Conventionally, individual tests are carried out on all samples. However, in exemplary embodiments of the invention, a plurality of samples are tested at the same time for whether they have a specific characteristic, and thus, positive samples can be detected from pool test result data.

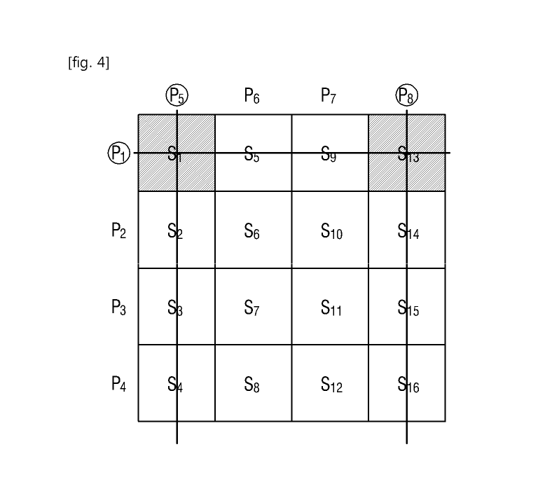

The detection of positive samples may be performed as illustrated in FIG. 4. Referring to FIG. 4, samples S₁ to S₁₆ are arranged in a 4*4 matrix. Samples of each row or each column of the matrix are pooled in the same pool, and are tested to determine whether each pool shows a specific characteristic.

In response to there existing pools showing a positive reaction, a sample corresponding to a point where a positive row pool and a positive column pool intersect in a 2D n*m matrix is determined to be positive.

More specifically, a sample at a point of intersection between a positive row pool and a positive column pool of the 2D n*m matrix may be determined to be positive. For example, as illustrated in FIG. 4, in response to pools P₁, P₅, and P₈ being positive, the samples S₁ and S₁₃ may be determined to be positive. According to this principle, the intensity of a signal indicating a positive reaction measured from the pool P₁ shows must be equal to the sum of the intensities of signals indicating positive reactions measured from the pools P₅ and P₅. To determine whether samples are equally pooled in each pool, the premise that the intensity of a signal indicating a positive reaction measured from a pool is proportional to the number of positive samples in the pool.

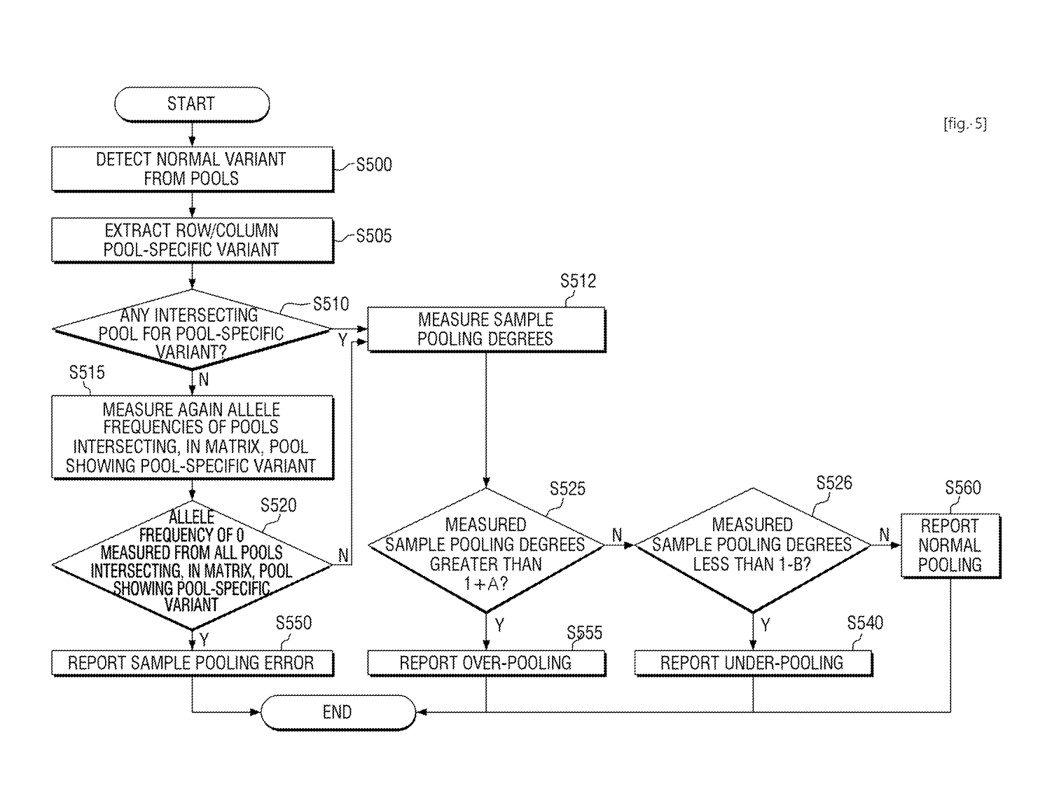

A pool test result verification method according to an exemplary embodiment of the invention will hereinafter be described with reference to FIGS. 5 to 9. The pool test result verification method may be performed by a computing device. The computing device may be the pool test result verification apparatus 100 or 200 of FIG. 1 or 2. For convenience, a description of by whom each step of the pool test result verification method is to be performed may or will be omitted.

The pool test result verification method will hereinafter be described with reference to FIG. 5. Referring to FIG. 5, a normal variant is detected from pools (S500). The normal variant is for testing whether there is an ingredient causing a particular disease or virus and is a target for which each sample is to be tested.

Once the detection of the normal variant, i.e., operation S500, is complete, a pool test result verification process is performed to determine whether the results of the detection of the normal variant are erroneous because of any left-out sample or any under-pooled or over-pooled sample.

More specifically, a row pool-specific variant or a column pool-specific variant is extracted (S505). A variant showing a positive reaction only in one of n rows of a 2D n*m matrix may be detected. Similarly, a variant showing a positive reaction only in one of m columns of the matrix may be detected. A variant that appears only in one column or row of the matrix used in a pool test may be defined as a pool-specific variant.

The pool-specific variant, unlike the normal variant, is for identifying pools that are different from one another. Thus, the pool-specific variant, which is for use in the verification of pool test result data, may preferably be based on a genomic area with high heterogeneity. Thus, a specific variant needs to be acquired from each individual sample. For this, in order not to complicate the acquisition of a specific variant from each individual sample even with an increasing number of pooled samples, a method may be used in which a genomic area with high heterogeneity such as HLA genes or mitochondrial DNA is included in a target, or in which DNA fragments that are distinguished from an individual in sample pooling are inserted into the DNA of an individual sample and are then captured.

Once the pool-specific variant is extracted (S505), a determination is made as to whether there is any intersecting pool among pools intersecting, in the matrix, a pool showing a positive reaction to the pool-specific variant (S510). The term “intersecting pool”, as used herein, may indicate a pool intersecting, in the matrix, the pool showing a positive reaction to the pool-specific variant and also showing a positive reaction to the pool-specific variant. For example, as illustrated in FIG. 4, in response to the pool P₁ being the pool showing a positive reaction to the pool-specific variant, a determination may be made as to whether there is a pool from which the same variant as the pool-specific variant is detected among the pools P₅, P₆, P₇, and P₈ intersecting, in the matrix, the pool P₁.

In response to a determination being made that there is an intersecting pool for the pool-specific variant (S510), sample pooling degrees are measured based on the intensity of a signal showing a positive reaction to the intersecting pool (S512), and the measured sample pooling degrees may be compared with a value of 1 (S525) so as to determine whether each sample is equally pooled (S526). Operation S512 will be described later in further detail with reference to FIG. 9.

On the other hand, if there is no intersecting pool for the pool-specific variant, it may be determined that a particular sample showing a positive reaction to the pool-specific variant has been left out from being pooled or has been under-pooled by less than a predefined amount. More specifically, if the particular sample is under-pooled by less than the predefined amount, a determination may be made in operation S510 that there is no intersecting pool for the pool-specific variant. To determine a pool to be positive with respect to the pool-specific variant, more variants than a minimum required variant quantity need to be detected. However, if the particular sample is under-pooled by less than the predefined amount, the minimum required variant quantity cannot be met.

In the present exemplary embodiment, in response to a determination being made in operation S510 that there is no intersecting pool for the pool-specific variant, it may be determined that a variant detection process has not been properly performed in operation S500.

In the present exemplary embodiment, all the pools may be subjected again to operation S510, or only samples that are under-pooled by less than the predefined amount may be selectively subjected again to operation S510. First, the minimum required variant quantity may be lowered as much as possible, and the allele frequencies of pools intersecting, in the matrix, a positive pool showing the pool-specific variant may be measured again without noise filtering (S515).

In response to an allele frequency of 0 being measured from all the pools intersecting, in the matrix, the positive pool (S520), it may be determined that a positive sample has been left out from being pooled, and a sample pooling error is reported (S550). Since no error sample can be selected, the entire pools may be pooled again, and may then be subjected again to a normal variant detection process.

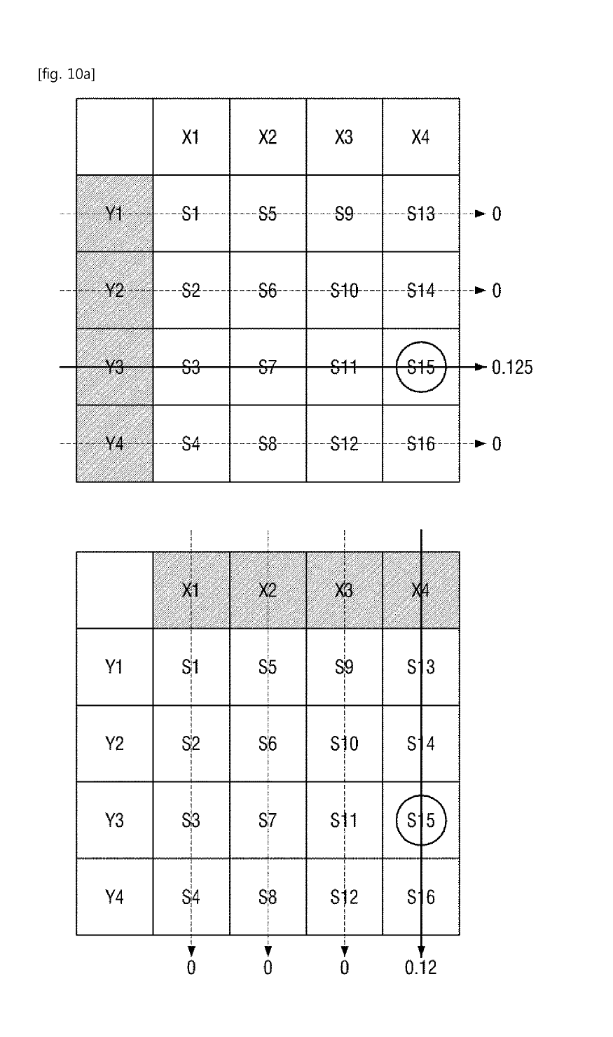

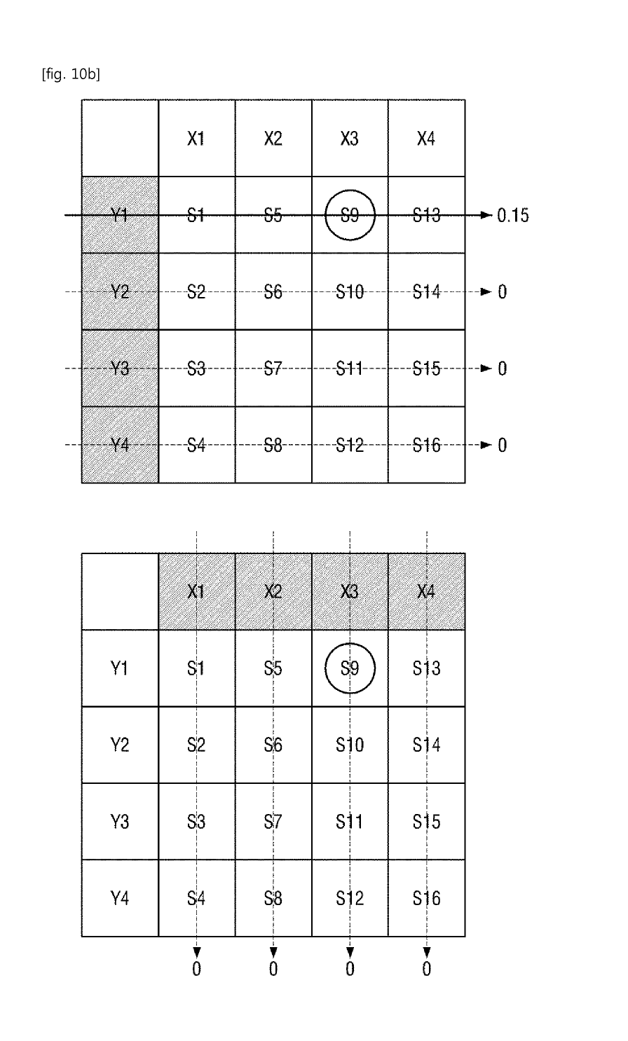

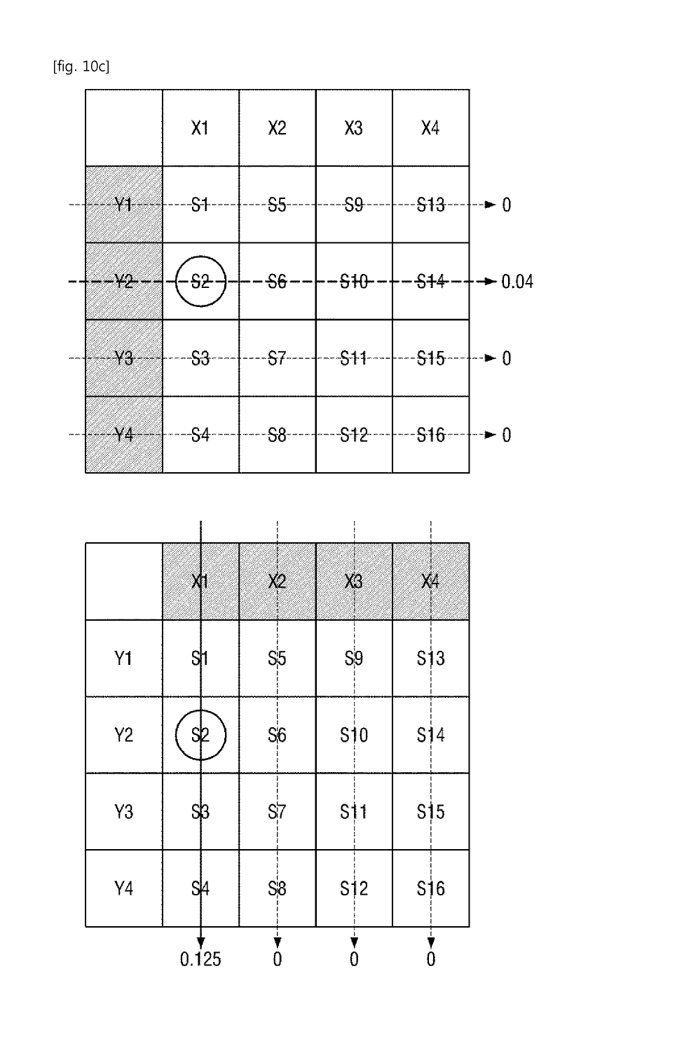

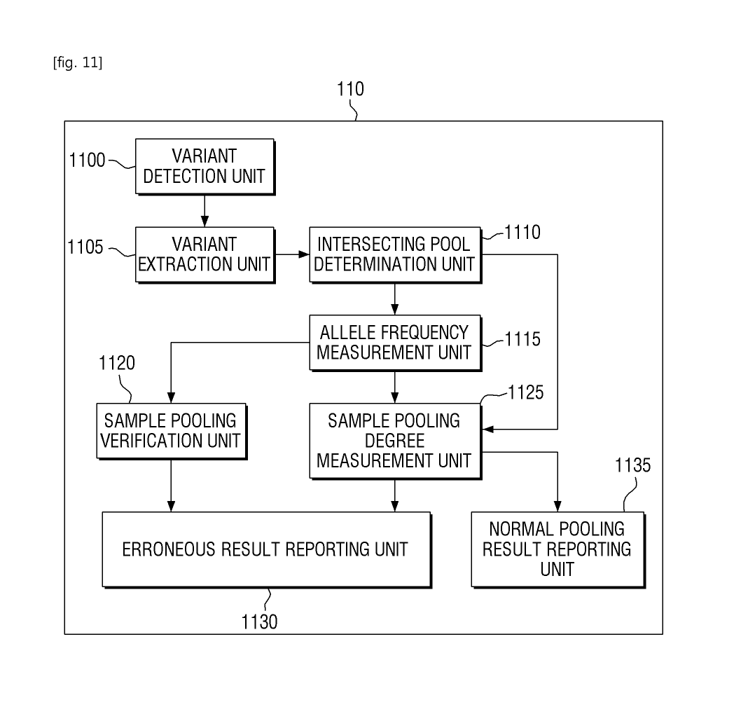

In response to there existing a pool from which an allele frequency of greater than 0 is detected among the pools intersecting, in the matrix, the positive pool, sample pooling degrees may be measured (S512). Then, in response to the measured sample pooling degrees being greater than 1+α (S525), over-pooling is reported (S555). On the other hand, in response to the measured sample pooling degrees being less than 1−β (S526), under-pooling is reported (S540), and the pool test result verification method ends. In response to the measured sample pooling degrees being in the range from 1−β to 1+α, normal pooling is reported (S560). An abnormally pooled sample, i.e., a sample not properly pooled by the predefined amount, i.e., may be selected using a pool matrix, which will be described later with reference to FIG. 10C.

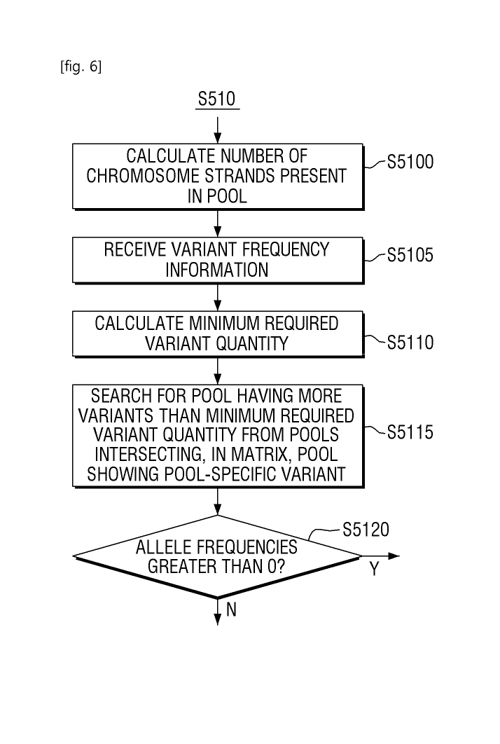

FIG. 6 is a detailed flowchart illustrating a process of determining whether there is an intersecting pool for a pool-specific variant, as performed in the pool test result verification apparatus according to the exemplary embodiment of FIG. 5, i.e., operation S510 of FIG. 5.

The number of chromosome strands present in each of the pool showing the pool-specific variant and an intersecting pool for the pool showing the pool-specific variant is calculated (S5100). The number of chromosome strands present in a pool may be calculated by Equation (1):

Number of Chromosome Strands Present in Pool=Σᵢ₋₁^{(norm)}Number of Chromosome Strands Present in Sample i.

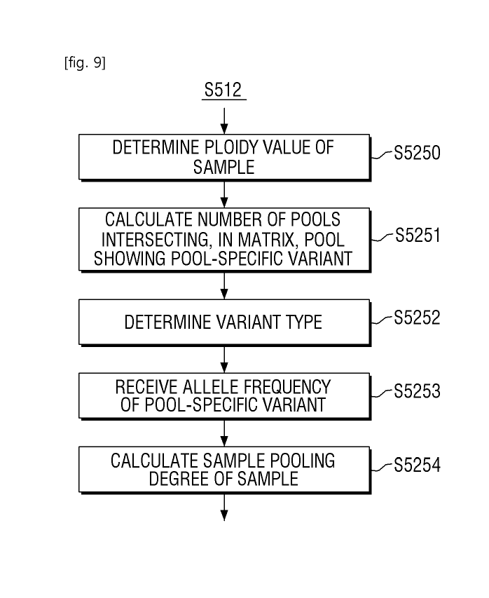

The number of chromosome strands present in a pool is equal to the sum of the numbers of chromosome strands present in all pooled samples in the pool. The number of chromosome strands present in a sample may be determined by the sex of the sample and the type of the chromosome. More specifically, as illustrated in FIG. 8, in the case of a female sample, each sex chromosome and each autosomal chromosome have two strands, but mitochondrial DNA has only one strand. On the other hand, in the case of a male sample, each autosomal chromosome have two strands, but each sex chromosome and mitochondrial DNA have one strand. However, the invention is not limited to what is illustrated in FIG. 8, and the number of chromosome strands may vary depending on the type of sample and the type of chromosome.

Referring back to FIG. 6, variant frequency information of the pool-specific variant may be received (S5105). The variant frequency information may be received from an external source. Alternatively, in response to a method being used in which during sample pooling, DNA fragments that are distinguished from an individual are inserted into the DNA of an individual sample or a genomic area with high heterogeneity is included in a target, the ratio of inserted DNA fragments may be used instead of the variant frequency information.

By using the chromosome strand quantities obtained in S5100 and the variant frequency information obtained in operation S5105, a minimum required variant quantity may be calculated (S5110), as shown in Equation (2):

$$Minimum Required Variant Quantity = {log}_{( Number of Allelic Combinations )} \frac{Chromosome Strand Quantity of Pool}{Variant Frequency}$$

where the number of allelic combinations means the number of combinations of base forms expressing each variant. Even different base sequences may express the same variant.

An intersecting pool for the pool-specific variant may be determined to be positive only if the pool-specific variant is detected therefrom at least a number of times corresponding to the minimum required variant quantity. A determination is made as to whether there is a positive pool among the pools intersecting, in the matrix, the pool-specific variant (S5115). As already mentioned above with reference to FIG. 5, a determination may be made as to whether there is an intersecting pool for the pool-specific variant (S510), and in response to a determination being made that there is an intersecting pool for the pool-specific variant, sample pooling degrees are measured (S512) so as to determine whether each sample has been properly pooled by the predefined amount. In response to a determination being made that there is no intersecting pool for the pool-specific variant, the pool test result verification method may return to operation S515 to perform an allele frequency measurement process again without noise filtering because there is a likelihood that sample pooling may not have been properly performed.

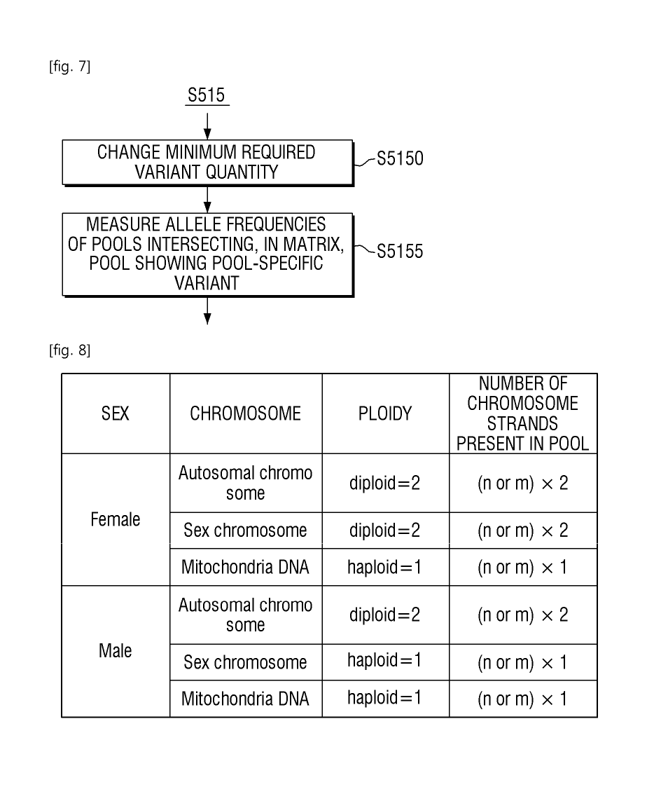

FIG. 7 is a detailed flowchart illustrating a process of calculating the allele frequencies of intersecting pools, as performed in the pool test result verification apparatus according to the exemplary embodiment of FIG. 5, i.e., operation S515 of FIG. 5.

Referring to FIG. 7, the minimum required variant quantity obtained in operation S510 of FIG. 6 is changed (S5150). More specifically, the minimum required variant quantity is lowered, and then, a search for an intersecting pool for the pool-specific variant is conducted again (S5155). If the minimum required variant quantity is lowered as much as possible, a positive reaction may be detected even from samples that are pooled by less than the predefined amount during the search for an intersecting pool for the pool-specific variant (S5155). By using this principle, the allele frequencies of the pools intersecting, in the matrix, the pool showing the pool-specific variant may be measured (S5155).

FIG. 8 shows different types of chromosomes and their respective number of strands. Referring to FIG. 8, in the case of a female sample, each sex chromosome and each autosomal chromosome have two strands, but mitochondrial DNA has only one strand. On the other hand, in the case of a male sample, each autosomal chromosome have two strands, but each sex chromosome and mitochondrial DNA have one strand. However, the invention is not limited to what is illustrated in FIG. 8, and the number of chromosome strands may vary depending on the type of sample and the type of chromosome.

FIG. 9 is a detailed flowchart illustrating a process of measuring a sample pooling degree, as performed in the pool test result verification apparatus according to the exemplary embodiment of FIG. 5, i.e., operation S512 of FIG. 5.

Referring to FIGS. 8 and 9, a ploidy value of a sample is determined (S5250). A human sex chromosome is a haploid and has a ploidy level of 1, and a human autosome is a diploid and has a ploidy level of 2. The number of pools intersecting, in the matrix, the pool showing the pool-specific variant is calculated (S5251). In the 2D n*m matrix, in response to the pool showing the pool-specific variant being a row pool, the number of pools intersecting, in the matrix, the pool showing the pool-specific variant may be m, and in response to the pool showing the pool-specific variant being a column pool, the number of pools intersecting, in the matrix, the pool showing the pool-specific variant may be n.

The variant type of the pool-specific variant is determined (S5252) based on the allele frequency of the pool-specific variant. For example, genotype AA, which is a reference genotype, may be determined to have a variant value of 0, genotype AB, which is a heterozygous variant genotype, may be determined to have a variant value of 1, and genotype BB, which is a homozygous variant genotype, may be determined to have a variant value of 2.

In response to there existing an intersecting pool for the pool-specific variant, allele frequency measurements obtained in operation S510 may be used. On the other hand, in response to there being no intersecting pool for the pool-specific variant, allele frequency measurements obtained in operation S515 may be used. Either the allele frequency measurements obtained in operation S510 or the allele frequency measurements obtained in operation S515 may be provided (S5253).

A sample pooling degree of the sample may be calculated (S5254) using ploidy information obtained in operation S5250, intersecting pool quantity information obtained in S5251, and variant type information obtained in operation S5252.

More specifically, the sample pooling degree of the sample may be calculated by Equation (3):

$$Sample Pooling Degree = \frac{pi}{z} * f$$

where p=2 if the sample is a diploid, p=1 if the sample is a haploid, i represents the number of pools intersecting, in the matrix, the pool showing the pool-specific variant, z represents the variant value of the pool-specific variant, and f represents the allele frequency of the pool-specific variant.

FIGS. 10A through 10C show allele frequencies for calculating sample pooling degrees of samples S₁₅, S₉, and S₂ Equation (3).

Referring to FIG. 10A, among four row pools ranging from a pool Y₁ to a pool Y₄, a pool Y₃ shows a positive reaction to a pool-specific variant. Since the allele frequency of the pool Y₃ is 0.125, i.e., ⅛ of the total number of chromosomes present in all the pools in a matrix, the pool-specific variant may be determined to be a heterozygous SNP.

Allele frequencies of pools X₁ through X₄ intersecting the pool Y₃ are measured. The sample pooling degree of a sample S₁₅ may be calculated using the measured allele frequencies, as shown in the following equation:

$$Sample Pool Degree of {S}_{15} in {X}_{4} = \frac{2 * 4}{1} * 0.12 = 0.96$$

$$Sample Pool Degree of {S}_{15} in {Y}_{3} = \frac{2 * 4}{1} * 0.125 = 1.$$

The sample S₁₅ has a ploidy value of 2, i.e., p=2, and i=4 because the matrix is 4×4. Since the pool-specific variant is a heterozygous variant, z=1. Since the variable f in Equation (3) represents allele frequency, values of 0.12 and 0.125 are substituted for f for the pools X₄ and Y₃, respectively

Accordingly, the sample pooling degree of the sample S₁₅ may be determined. That is, the sample S₁₅ may be determined to be pooled in the pool X₄ by 96% of a predefined amount, and may be determined to be pooled in the pool Y₃ by 100% of the predefined amount.

If the sample pooling degree of the sample S₁₅ is greater than 1, the sample S₁₅ may be determined to be over-pooled.

FIG. 10B illustrates a case when the pool-specific variant is detected from a row pool of the matrix and the column pools intersecting the row pool all have an allele frequency of 0. Referring to FIG. 10B, even though the allele frequency of the pool Y₁ is sufficiently high enough for the pool-specific variant to be detected from the pool Y₁, no allele frequency is measured from any one of the pools X₁ through X₄ intersecting the pool Y₁. In this case, it may be determined that a sample S₉ having the pool-specific variant is highly likely to have been left out from the pool X₃. However, since it is difficult to determine which of the samples S₁, S₅, S₉, and S₁₃ have actually been left out, the entire pools need to be subjected to a test again.

FIG. 10C illustrates a case when the pool-specific variant is normally detected from a column pool of the matrix and a low allele frequency is measured from the row pools intersecting the column pool. Referring to FIG. 10C, an allele frequency of 0.125 is measured from the pool X₁. Then, a positive reaction is supposed to be detected from any one of the pools Y₁ through Y₄ intersecting the pool X₁. However, none of the pools Y₁ through Y₄ show a positive reaction, and only an insignificant allele frequency is detected from the pool Y₂. In this case, the sample pooling degree of a sample S₂ may be calculated, as shown in the following equation:

$$Sample Pooling Degree of {S}_{2} in {X}_{1} = \frac{2 * 4}{1} * 0.12 = 0.96$$

$$Sample Pool ing Degree of {S}_{2} in {Y}_{2} = \frac{2 * 4}{1} * 0.04 = 0.32$$

The sample S₂ in the pool Y₂ may be determined to be pooled by only 32% of the predefined amount. It may also be determined that because of the sample S₂ being under-pooled, a low allele frequency has been measured from the pool Y₂, and that the detection of a normal variant has not been properly performed.

In this case, a normal variant detection process may be performed again only on the sample S₂, or on the entire pools.

The pool test result verification method according to the exemplary embodiment can even determine whether normal samples are properly pooled and are thus distinguishable from existing false positive determination methods. That is, the pool test result verification method according to the exemplary embodiment not only can detect errors, but also can even determine whether normal samples are properly pooled.

FIG. 11 is a block diagram of a pool test result verification apparatus according to an exemplary embodiment of the invention.

Referring to FIG. 11, the pool test result verification apparatus may include a variant detection unit 1100, a variant extraction unit 1105, an intersecting pool determination unit 1110, an allele frequency measurement unit 1115, and a sample pooling verification unit 1120. The pool test result verification apparatus may also include a sample pooling degree measurement unit 1125, which determines whether each sample is pooled by a predefined amount, an erroneous result reporting unit 1130, which reports an error in response to each sample not being determined to be properly pooled, and a normal pooling result reporting unit 1135, which reports normal pooling in response to each sample being determined to be properly pooled.

The variant detection unit 1100 detects a normal variant to determine whether each pooled sample has a specific characteristic. To determine whether each sample has been equally pooled without being left out with respect to the detected normal variant, the variant extraction unit 1105 extracts a pool-specific variant.

The pool-specific variant may be a variant present in only one pool of a 2D n*m matrix consisting of n row pools and m column pools. In response to the pool-specific variant being detected by the variant extraction unit 1105, the intersecting pool determination unit 1100 determines whether the pool-specific variant is also detected equally from pools intersecting, in the matrix, a pool having the pool-specific variant. In this case, more allele frequency measurements than a minimum required variant quantity need to be obtained.

The allele frequency measurement unit 1115 lowers the minimum required variant quantity as low as possible and thus allows even an insignificant allele frequency to be detected.

In response to no allele frequency measurements being obtained by the allele frequency measurement unit 1115, the sample pooling verification unit 1120 determines that a sample having the pool-specific variant has been left out, and transmits an error signal indicating the existence of a left-out sample to the erroneous result reporting unit 1130.

In response to the error signal indicating the existence of a left-out sample being received, the erroneous result reporting unit 1130 reports an error.

The sample pooling degree measurement unit 1125 may measure sample pooling degrees using allele frequency measurements received from the intersecting pool determination unit 1110 or allele frequency measurements received from the allele frequency measurement unit 1115. If allele frequency measurements obtained by the intersecting pool determination unit 1110 meet the minimum required variant quantity, the intersecting pool determination unit 1110 may transmit the corresponding allele frequency measurements to the sample pooling degree measurement unit 1125. On the other hand, if the allele frequency measurements obtained by the intersecting pool determination unit 1110 do not meet the minimum required variant quantity, the allele frequency measurement unit 1115 may transmit allele frequency measurements to the sample pooling degree measurement unit 1125.

The sample pooling degree measurement unit 1125 may measure a sample pooling degree of the sample having the pool-specific variant by using Equation (3). In response to the measured sample pooling degree being less than 1, the sample pooling degree measurement unit 1125 may determine the sample having the pool-specific variant as being under-pooled by less than a predefined amount. On the other hand, in response to the measured sample pooling degree being greater than 1, the sample pooling degree measurement unit 1125 may determine the sample having the pool-specific variant as being over-pooled by more than the predefined amount.

In response to the measured sample pooling degree being within a predetermined error range with respect to the value of 1, the sample pooling degree measurement unit 1125 determines that the sample having the pool-specific variant as being properly pooled, and transmits a signal to the normal pooling result reporting unit 1135. On the other hand, in response to the measured sample pooling degree being far apart from 1, the sample pooling degree measurement unit 1125 transmits the location of the sample having the pool-specific variant in the matrix and the measured sample pooling degree to the erroneous result reporting unit 1130.

The elements of the pool test result verification apparatus of FIG. 11 may include software or hardware elements such as a field-programmable gate array (FPGA) or an application-specific integrated circuit (ASIC). However, the elements of the pool test result verification apparatus of FIG. 11 are not particularly limited to software or hardware elements. That is, the elements of the pool test result verification apparatus of FIG. 11 may be configured to reside in an addressable storage medium or to execute one or more processors. Functions provided within the elements of the pool test result verification apparatus of FIG. 11 may be further separated into additional elements or may be incorporated into fewer elements.

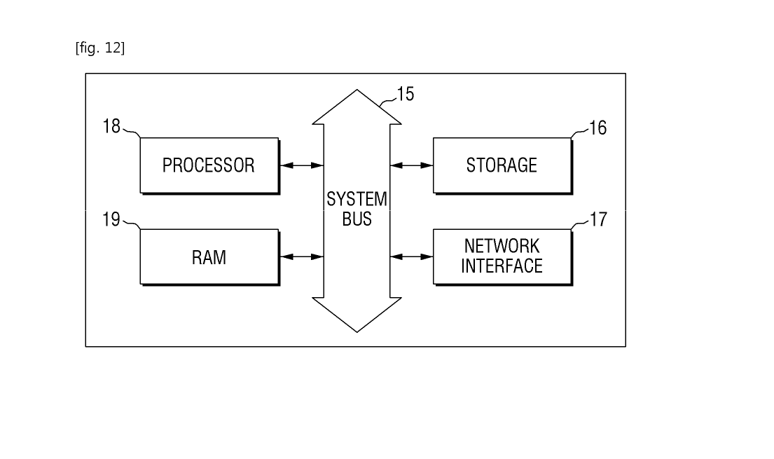

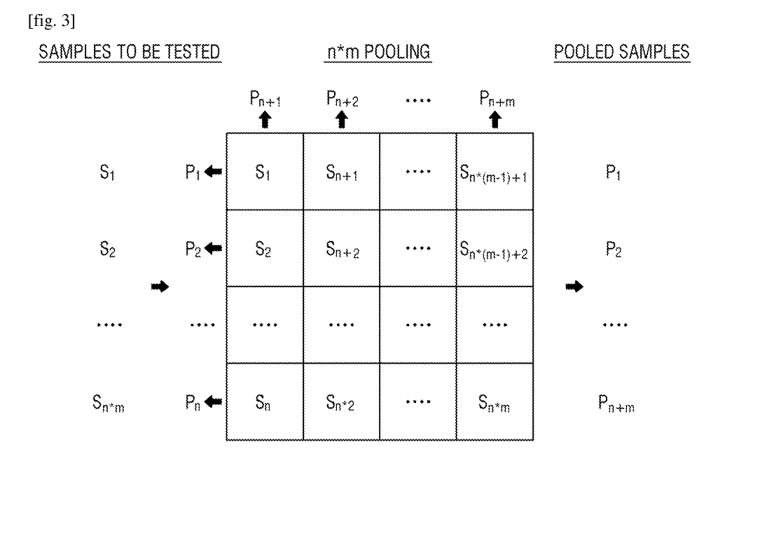

FIG. 12 is a hardware configuration view of the pool test result verification apparatus according to the exemplary embodiment of FIG. 11. The pool test result verification apparatus of FIG. 11 may have a structure as illustrated in FIG. 12. The pool test result verification apparatus of FIG. 11 may include a processor 18, which executes instructions, a storage 16 in which pool test result data is stored, a memory 19, a network interface 17, which is for transmitting data to or receiving data from an external device, a data bus 15, which is connected to the storage 16, the network interface 17, the processor 18, and the memory 19 and serves as a path for the transfer of data.

A computer program providing a pool test result verification function includes instructions for detecting a normal variant from each sample, detecting a pool-specific variant, determining whether there is an intersecting pool for a pool showing the pool-specific variant, measuring the allele frequencies of pools intersecting, in the matrix, the pool showing the pool-specific variant to determine whether each sample has been properly pooled, whether there is any left-out sample, and by what percentage of the predefined amount any under-pooled sample has been pooled and instructions for reporting result data regarding the sample pooling degree of each sample.

In an exemplary embodiment, the computer program may also include instructions for, in response to a determination being made that sample pooling has been abnormally performed, selecting only abnormal samples and subjecting the selected samples to a normal variant detection process again.

What is claimed is:

1. A pool test result verification method, comprising:
receiving pool test result data obtained by performing a pool test on a plurality of pools, the plurality of pools being arranged based on a two-dimensional (2D) matrix having a plurality of rows and a plurality of columns, the pool test result data including allele frequencies of the plurality of pools;
extracting a pool-specific variant from the matrix using the allele frequencies, the pool-specific variant being one of a row pool-specific variant associated with only one row of the plurality of rows, or a column pool-specific variant associated with only one column of the plurality of columns;
identifying a positive pool which reacts positively with the pool-specific variant;
determining whether a positive intersecting pool exists, wherein the positive intersecting pool reacts positively with the pool-specific variant and intersects in the matrix with the positive pool; and
determining whether the pool test result data is erroneous based on results of the determining whether the positive intersecting pool exists.

2. The pool test result verification method of claim 1, wherein:
the determining whether the positive intersecting pool exists comprises performing a noise-filtering on the plurality of pools to remove pools having allele frequencies below a predefined value and making a first determination; and
the determining whether the pool test result data is erroneous further comprises:
in response to the first determination indicating that the positive intersecting pool does not exist, not performing the noise-filtering and making a second determination, and
in response to the second determination indicating that the positive intersecting pool does not exist, determining that the pool test result data is erroneous and generating error reporting data indicating a sample pooling error.

3. The pool test result verification method of claim 1, wherein:
the determining whether the positive intersecting pool exists comprises performing a noise-filtering on the plurality of pools to remove pools having allele frequencies below a predefined value and making a first determination; and
the determining whether the pool test result data is erroneous comprises:,
in response to the first determination indicating that the positive intersecting pool does not exist, not performing the noise-filtering and making a second determination, and
in response to the second determination indicating that the positive intersecting pool does exist, measuring sample pooling degrees of a sample reacting positively with the pool-specific variant in the positive intersecting pool and the positive pool.

4. The pool test result verification method of claim 3, wherein the sample pooling degrees are calculated by the following equation:
(p*i/z)*f
where p=2 in response to the sample being a diploid, p=1 in response to the sample being a haploid, i represents a number of pools intersecting the positive pool, z=1 in response to the pool-specific variant being a heterozygous variant, z=2 in response to the pool-specific variant being a homozygous variant, and f represents an allele frequency of the pool-specific variant.

5. The pool test result verification method of claim 4, wherein the determining whether the pool test result data is erroneous further comprises:
in response to the sample pooling degrees being greater than 1+α, where a represents a first predefined error tolerance, determining that the pool test result data is erroneous and generating error reporting data indicating over-pooling;
in response to the sample pooling degrees being less than 1−β, where β represents a second predefined error tolerance, determining that the pool test result data is erroneous and generating error reporting data indicating under-pooling; and
in response to the sample pooling degrees being in a range from 1+β to 1+α, determining that the pool test result data is not erroneous, and generating error reporting data indicating normal pooling.

6. The pool test result verification method of claim 1, wherein the determining whether the pool test result data is erroneous further comprises, in response to sample pooling degrees being within a predefined error tolerance range, determining that the pool test result data is not erroneous, and generating normal reporting data.

7. A computer program recorded on a non-transient computer-readable medium for executing, in connection with a computing device, the steps of:
receiving pool test result data, which is obtained by performing a pool test on a plurality of pools, the plurality of pools being arranged based on a 2D matrix having a plurality of rows and a plurality of columns, the pool test result data including allele frequencies of the plurality of pools;
extracting a pool-specific variant from the matrix using the allele frequencies, the pool-specific variant being one of a row pool-specific variant associated with only one row of the plurality of rows, or a column pool-specific variant associated with only one column of the plurality of columns;
identifying a positive pool which reacts positively with the pool-specific variant;
determining whether a positive intersecting pool exists, wherein the positive intersecting pool reacts positively with the pool-specific variant and intersects in the matrix with the positive pool; and
determining whether the pool test result data is erroneous based on results of the determining whether the positive intersecting pool exists.

8. A pool test result verification apparatus, comprising:
one or more processors;
a network interface;
a non-transient computer-readable memory; and
a storage device having recorded thereon an execution file of a computer program that is loaded in the memory to be executed by the processors,
wherein the computer program comprises:
instructions for receiving pool test result data, which is obtained by performing a pool test on a plurality of pools being arranged based on a 2D matrix having a plurality of rows and a plurality of columns, the pool test result data including allele frequencies of the plurality of pools;
instructions for extracting a pool-specific variant from the matrix using the allele frequencies, the pool-specific variant being one of a row pool-specific variant associated with only one row of the plurality of rows, or a column pool-specific variant associated with only one column of the plurality of columns, for identifying a positive pool which reacts positively with the pool-specific variant, and for determining whether a positive intersecting pool exists, wherein the positive intersecting pool reacts positively with the pool-specific variant and intersects in the matrix with the positive pool; and
instructions for outputting data to display verification results of the pool test result data according to results of the determining whether the positive intersecting pool exists.

9. The pool test result verification apparatus of claim 8, wherein the network interface is connected to an allele frequency measurement apparatus, and the computer program further comprises:
instructions for receiving allele frequencies from the allele frequency measurement apparatus via the network interface; and
instructions for measuring a sample pooling degree in the positive intersecting pool and determining whether the pool test result data is erroneous based on the sample pooling degree.

10. A pool test result verification apparatus, comprising:
a pool-specific variant extraction unit receiving pool test result data, which is obtained by performing a pool test on a plurality of pools being arranged based on a 2D matrix having a plurality of rows and a plurality of columns, extracting a pool-specific variant from the matrix using allele frequencies of the plurality of pools included in the pool test result data, the pool-specific variant being one of a row pool-specific variant associated with only one row of the plurality of rows, or a column pool-specific variant associated with only one column of the plurality of columns, and identifying a positive pool which reacts positively with the pool-specific variant;
an intersecting pool determination unit determining whether a positive intersecting pool exists, wherein the positive intersecting pool reacts positively the pool-specific variant and intersects in the matrix with the positive pool ; and
a sample pooling verification unit determining whether each sample has been properly pooled for the pool-specific variant based on the allele frequencies.

11. The pool test result verification apparatus of claim 10, further comprising:
a sample pooling degree measurement unit determining whether sample pooling degrees in the positive pool and the positive intersecting pool are within a predefined error tolerance range.
